(19) United States
(12) Patent Application Publication
(10) Pub. No.: US 2025/0135754 A1
(43) Pub. Date: May 1, 2025

(54) FULL BODY TEXTURED MATERIAL AND PREPARATION METHOD THEREFOR

(71) Applicants: Pei Tong CHAO, Tainan City Taiwan (CN); FOSHAN SHUNDE PURETE MECHANICAL CO., LTD., Foshan city, Guangdong (CN)

(72) Inventor: Pei Tong CHAO, Tainan City Taiwan (CN)

(73) Assignees: Pei Tong CHAO, Tainan City Taiwan (CN); FOSHAN SHUNDE PURETE MECHANICAL CO., LTD., Foshan city, Guangdong (CN)

(21) Appl. No.: 18/833,535

(22) PCT Filed: Sep. 21, 2022
(86) PCT No.: PCT/CN2022/120353

§ 371 Date: Jul. 26, 2024

(30) Foreign Application Priority Data
Sep. 22, 2021 (CN) 202111105101.1

(51) Int. Cl. B32B 27/00; B29C 43/00; B29C 43/22; B29C 43/26; B29K 27/06; B29K 105/00; B29K 105/26; B29K 509/00; B29L 9/00; E04F 15/10

(52) U.S. Cl. CPC B32B 27/00; B29C 43/003; B29C 43/222; B29C 43/265; E04F 15/107; B29C 2795/007; B29K 2027/06; B29K 2105/251; B29K 2105/26; B29K 2509/00; B29K 2995/0021; B29K 2995/0074; B29L 2009/005; B32B 2307/4023; B32B 2451/00

(57) ABSTRACT

A full body textured material includes a textured substrate, the internal texture of the substrate extends to the surface, the components of the substrate comprise a thermoplastic polymer and a filler, the filler is one of an inorganic filler or a natural plant fiber filler, and the texture is obtained by performing distribution by a digital distribution machine. Compared with sintered stone, the present disclosure has the characteristics of low cutting difficulty, low investment costs, and low production energy consumption.

### CROSS-REFERENCE TO RELATED APPLICATION

This application is the United States national phase of International Patent Application No. PCT/CN2022/120353, filed Sep. 21, 2022, and claims priority to Chinese Patent Application No. 202111105101.1, filed Sep. 22, 2021, the disclosures of each are hereby incorporated by reference in their entireties.

### TECHNICAL FIELD

The present disclosure pertains to the technical field of decoration materials, and particularly relates to a full body textured material and a preparation method therefor.

### BACKGROUND

Plastic rubber floor covering roll products have been widely used for a long term, especially in public installations, such as hospitals, office buildings, kindergartens, etc., and are made of PVC, rubber, TPU, linen, etc. The products are divided into composite and homogeneous transparent products according to different process practices. Because of good wear resistance, the homogeneous transparent products are used more in places with more people, but the patterns thereof cannot be the same as those of actual stone and wood textures. Therefore, the composite products are used in some areas. The composite products need to be protected by a transparent layer. Once the transparent layer is worn out, it is necessary to replace floors. The service life of a homogeneous transparent product is five or more times that of a composite product of the same thickness, but the homogeneous transparent product is restricted due to the surface color thereof. Sheets are also often made of composite films, which are attached to substrates after patterns are printed on the printed films, and consequently, pollution caused by printing inks is also increasing.

Simulated stone or wood textures have been continuously developed for plastic floor products. With regard to current floor products, sintered stone is considered an emerging and “revolutionary new material” in the industry and are even praised as “Ferrari in the design industry”, “the Guinness in the decoration industry”, and “Wolverine in the construction industry.” Sintered stone is applicable to a wide variety of areas, such as exterior walls, interior space floors, backgrounds, countertops, and furniture, in which sintered stone can serve as an ideal material. However, the cutting and construction of sintered stones is not easy, the investment costs are overly high, the production energy consumption is excessively high, and the products cannot be recycled, which is a huge consumption to the environment.

### SUMMARY

The present disclosure is intended to solve at least one of the technical problems existing in the above prior art. To this end, the present disclosure proposes a full body textured material and a preparation method therefor, which capture the deficiencies of existing plastic floors, ceramic tiles, and sintered stones, improve production processes, and further optimize ground materials, so as to achieve the purposes of reducing the difficulty of cutting, reducing investment costs, reducing production energy consumption, and recycling materials.

According to one aspect of the present disclosure, proposed is a full body textured material, comprising a textured substrate, wherein the internal texture of the substrate extends to the surface, the components of the substrate comprise a thermoplastic polymer and a filler, and the filler is one of an inorganic filler or a natural plant fiber filler. The natural plant fiber comprises one or more of wood powder, bamboo powder, rice husk powder, or straw powder.

According to one aspect of the present disclosure, the texture is a stone texture or a wood texture.

In some embodiments of the present disclosure, a pattern layer and/or a protective layer is further provided on the substrate, and the protective layer is a UV cured layer or a wax layer.

In some embodiments of the present disclosure, an acoustic layer is further provided below the substrate.

In some embodiments of the present disclosure, the full body textured material is a plank floor or a roll floor or a wall board with a lock. When the floor has a lock, the floor can be installed with the lock, and when the floor is a roll, the floor can be installed with a glue.

The present disclosure further provides a preparation method for the full body textured material, comprising the following steps:
S1: importing a design pattern to be fabricated into a control computer of a digital distribution machine, placing base materials of different colors in raw material barrels of the digital distribution machine, and using a base material of a corresponding color according to a designed color;
S2: starting to run a conveyor belt under the digital distribution machine, and sprinkling the base materials to form the preset pattern, wherein the pattern can be produced continuously, or made into planks according to a required size; and
S3: upon completion of the distribution, performing a compression forming treatment on the base materials by a forming device to obtain the substrate.

In some embodiments of the present disclosure, the forming device can be a steel belt calender or a roller calender or a hot press. After the distribution, the base materials enter the forming device, directly or being carried by a carrier. A forming method comprises hot pressing, double steel belt calendering, or sprinkling the base materials on a layer of base cloth and then bringing same into a roller for calendering. Upon completion of the distribution, the base materials are further heated before entering the steel belt calender or the roller calender.

In some embodiments of the present disclosure, the formulation of the base material comprises a thermoplastic polymer, a filler, and a colorant, and the ratio of the thermoplastic polymer to the filler can be adjusted according to requirements, or a plasticizer can be added to formulate base materials with different hardness and softness. Colorants of different colors can be employed in different base material formulations. The base materials are one or more of granular, powdery, flaky, or viscous. The filler can be calcium carbonate or wood powder. The addition of the wood powder can form plastic wood, and make the wood texture contain wood components and aromas. The combination of base materials with different hardness can imitate naturally grown wood. There are soft and hard combinations in the wood, for example, scars and annual rings are harder, and the use of base materials of different formulations can achieve the effect of soft and hard combination. Subsequently, different textures can be created by manual scratching. Due to different hardness, there will be resistance during manual scratching, and different manual force strength will produce different textures of different depths, and therefore the combination of base materials with different hardness can produce rich texture effects.

In some embodiments of the present disclosure, the thermoplastic polymer is selected from one or more of PVC, PET, epoxy resins, or PE. The PVC is preferred.

In some embodiments of the present disclosure, the granular base material is prepared by mixing raw materials, carrying out granulation by means of extrusion or calendaring, and performing crushing and screening. Preferably, the particle size of the granular base material is 15-200 mesh.

In some embodiments of the present disclosure, the substrate can be fabricated into a full body textured substrate or a semi-full body textured substrate. When the substrate is full body textured, the base materials in step S2 are directly sprinkled on the conveyor belt; when the substrate is half-body textured, the conveyor belt carries a monochromatic base through the digital distribution machine, and the base materials in step S2 are sprinkled on the monochromatic base, an upper part of the formed substrate has a full body texture, and the lower part is monochromatic.

In some embodiments of the present disclosure, the monochromatic base is a plank or a roll, or is a base layer formed using a recycled material to perform thorough sprinkling and spreading. The material of the plank or roll can be the same or different from that of the base material, such as a PVC board+a base material containing PVC, a PP board+a base material containing PP, a PET board+a base material containing PETG, or a MDF board+a base material containing wood flour; the roll can be a non-woven fabric, glass fiber cloth, a PVC roll, etc. When the base layer uses a plank, the digital distribution machine can be connected to an extrusion production line. The digital distribution machine is arranged above the extruded plank, and the base materials can be continuously sprinkled on the extruded plank, and then calendered and formed. When the base layer uses a roll, two ends of the production line are respectively provided with an unwinding mechanism and a winding mechanism. In addition, the use of the recycled material as the base layer brings the benefit of greater environmental friendliness.

In some embodiments of the present disclosure, after step S3, the method further comprises the step of performing surface treatment on the substrate: performing waxing or UV cured surface brightness and haze treatment on the surface of the substrate, or printing with a digital printer a pattern the same as the substrate pattern, or printing a match pattern according to the pattern of the substrate.

In some embodiments of the present disclosure, when the match pattern is printed, a water-based ink, a UV ink, an oil-based ink, a corrosion ink, or a peeling ink can be used to perform texture stacking or depression treatment on the printed pattern according to the substrate, so as to present textures of the substrate. Specifically, a UV paint is placed on the textures, which is called stacking treatment. Another method is injecting an ink into a UV paint, to tear the UV surface to form textures, which is called depression treatment. There are many types of inks that can achieve depression. The textures can be produced by preheating reaction corrosion, or the textures can be formed by directly extruding the UV surface. For example, a crackable material is added to a paint of one color in multi-color paints of the printer to form a cracking ink. The crackable material can react with a UV lamp, and corresponds to textures to be produced in the design pattern. The cracking ink is printed on lines that are to produce deep and shallow textures. The ink has the characteristics of expansion and cracking after being heated. After UV irradiation, the cracking ink absorbs UV energy and peels off the UV paint on the surface to form embosses of varying heights. In parts by weight, the cracking ink contains 25-55 parts of a cracking resin and 20-45 parts of a photosensitizer.

According to a preferred embodiment of the present disclosure, the present disclosure has at least the following beneficial effects:

The present disclosure captures the deficiencies of existing plastic floors, ceramic tiles, and sintered stones, and uses thermoplastic polymer materials as main materials of a full body decoration material (floors or wallboards) allowing floors to have the environmental protection characteristics of plastic floors, and produces a variety of textures using a digital distribution machine, and can form textures with different hardness on the same substrate by combining base materials of different colors and different hardness, thereby producing rich texture effects and generating full body textures identical to those of real stone and wood materials, thereby solving the problem of current plastic floors incapable of producing real stone textures or wood textures. In addition, although current sintered stones are lifelike, sintered stones need to be processed by water jet cutting, pneumatic grinding, and other processes in a factory to complete all designed size specifications in the factory. If a designer carelessly measures sintered stones, the product certainly cannot be remedied, and re-fabrication will be time-consuming. Compared with the sintered stone, the full body floor of the present disclosure can be constructed on site with a wire saw or a blade as required with high accuracy without pollution. Furthermore, in terms of investment costs and production energy consumption, sintered stones require a press of tens of thousands of tons to be sufficient to be pressed into large plates, which are then highly fired at 1200° C. in a kiln. The costs of investing in a production line are as high as RMB150 million. These apparatuses and process conditions also result in high production energy consumption. The present disclosure can be produced using conventional apparatuses, the investment amount is about 30 million, and the costs and energy consumption are much lower. Additionally, the full body floor material of the present disclosure can be recycled and reused, and the performance of energy reduction, carbon reduction, and environmental protection is greatly improved.

### DETAILED DESCRIPTION

The concept of the present disclosure and the technical effects produced thereby will be clearly and completely described below with reference to examples, so as to fully understand the purposes, features, and effects of the present disclosure. Obviously, the described examples are only a part of examples of the present disclosure, rather than all the examples. On the basis of the examples of the present disclosure, other examples obtained by those skilled in the art without creative efforts all full within the scope of protection of the present disclosure.

A full body textured material includes a textured substrate, the internal texture of the substrate extending to the surface, the components of the substrate including a thermoplastic polymer and a filler, and the filler being one of an inorganic filler and a natural plant fiber filler. The natural plant fiber includes one or more of wood powder, bamboo powder, rice husk powder, or straw powder.

In some embodiments, the texture is a stone texture or a wood texture.

In some embodiments, a pattern layer and/or a protective layer is further provided on the substrate, and the protective layer is a UV cured layer or a wax layer.

In some embodiments, an acoustic layer is further provided below the substrate.

In some embodiments, the full body textured material is a plank floor or a roll floor or a wall board with a lock. When the floor has a lock, the floor can be installed with the lock, and when the floor is a roll, the floor can be installed with a glue.

A preparation method for a full body textured material includes the following steps:
S1: importing a design pattern to be fabricated into a control computer of a digital distribution machine, placing base materials of different colors in raw material barrels of the digital distribution machine, and using a base material of a corresponding color according to a designed color;
S2: starting to run a conveyor belt under the digital distribution machine, and sprinkling the base materials to form the preset pattern, wherein the pattern can be produced continuously, or made into planks according to a required size; and
S3: upon completion of the distribution, performing a compression forming treatment on the base materials by a forming device to obtain the substrate.

In some embodiments, the forming device can be a steel belt calender or a roller calender or a hot press. After the distribution, the base materials enter the forming device, directly or being carried by a carrier. A forming method includes hot pressing, double steel belt calendering, or sprinkling the base materials on a layer of base cloth and then bringing same into a roller for calendering. Upon completion of the distribution, the base materials are further heated before entering the steel belt calender or the roller calender.

In some embodiments, the formulation of the base material includes a thermoplastic polymer, a filler, and a colorant, and the ratio of the thermoplastic polymer to the filler can be adjusted according to requirements, or a plasticizer can be added to formulate base materials with different hardness and softness. Colorants of different colors can be employed in different base material formulations. The base materials are one or more of granular, powdery, flaky, or viscous. The filler can be calcium carbonate or wood powder. The addition of the wood powder can form plastic wood, and make the wood texture contain wood components and aromas. The combination of base materials with different hardness can imitate naturally grown wood. There are soft and hard combinations in the wood, for example, scars and annual rings are harder, and the use of base materials of different formulations can achieve the effect of soft and hard combination. Subsequently, different textures can be created by manual scratching. Due to different hardness, there will be resistance during manual scratching, and different manual force strength will produce different textures of different depths, and therefore the combination of base materials with different hardness can produce rich texture effects.

In some of the embodiments, the thermoplastic polymer is selected from one or more of PVC, PET, epoxy resins, or PE. The PVC is preferred.

In some embodiments, the granular base material is prepared by mixing raw materials, carrying out granulation by means of extrusion or calendaring, and performing crushing and screening. Preferably, the particle size of the granular base material is 15-200 mesh.

In some of these embodiments, the substrate can be fabricated into a full body textured substrate or a semi-full body textured substrate. When the substrate is full body textured, the base materials in step S2 are directly sprinkled on the conveyor belt; when the substrate is half-body textured, the conveyor belt carries a monochromatic base through the digital distribution machine, and the base materials in step S2 are sprinkled on the monochromatic base, an upper part of the formed substrate has a full body texture, and the lower part is monochromatic.

In some embodiments, the monochromatic base is a plank or a roll, or is a base layer formed using a recycled material to perform thorough sprinkling and spreading. The material of the plank or roll can be the same or different from that of the base material, such as a PVC board+a base material containing PVC, a PP board+a base material containing PP, a PET board+a base material containing PETG, or a MDF board+a base material containing wood flour; the roll can be a non-woven fabric, glass fiber cloth, a PVC roll, etc. When the base layer uses a plank, the digital distribution machine can be connected to an extrusion production line. The digital distribution machine is arranged above the extruded plank, and the base materials can be continuously sprinkled on the extruded plank, and then calendered and formed. When the base layer uses a roll, two ends of the production line are respectively provided with an unwinding mechanism and a winding mechanism. In addition, the use of the recycled material as the base layer brings the benefit of greater environmental friendliness.

In some embodiments, after step S3, the method further includes the step of performing surface treatment on the substrate: performing waxing or UV surface brightness and haze treatment on the surface of the substrate, or printing with a digital printer a pattern the same as the substrate pattern, or printing a match pattern according to the pattern of the substrate.

In some embodiments, when the match pattern is printed, a water-based ink, a UV ink, an oil-based ink, a corrosion ink, or a peeling ink can be used to perform texture stacking or depression treatment on the printed pattern according to the substrate, so as to present textures of the substrate. Specifically, a UV paint is placed on the textures, which is called stacking treatment. Another method is injecting an ink into a UV paint, to tear the UV surface to form textures, which is called depression treatment. There are many types of inks that can achieve depression. The textures can be produced by preheating reaction corrosion, or the textures can be formed by directly extruding the UV surface. For example, a crackable material is added to a paint of one color in multi-color paints of the printer to form a cracking ink. The crackable material can react with a UV lamp, and corresponds to textures to be produced in the design pattern. The cracking ink is printed on lines that are to produce deep and shallow textures. The ink has the characteristics of expansion and cracking after being heated. After UV irradiation, the cracking ink absorbs UV energy and peels off the UV paint on the surface to form embosses of varying heights. In parts by weight, the cracking ink contains 25-55 parts of a cracking resin and 20-45 parts of a photosensitizer.

### Example 1

In this example, a full body textured floor was prepared, which included an acoustic layer, a substrate, a pattern layer, and a UV cured protection layer from bottom to top. The inner texture of the substrate extended to the surface, and the floor was a plate with a lock. A preparation method therefor was as follows:

(1) Granulation: A substrate in this example consisted of three base materials with different hardness, and a formulation thereof was as shown in Table 1:

TABLE 1
Base material 1 (parts by weight)

| | |
|---|---|
| Stabilizer | 0.88 |
| PVC powder | 28.00 |
| Calcium carbonate filler | 71.12 |

Base material 2 (parts by weight))

| | |
|---|---|
| Stabilizer | 1.06 |
| PVC powder | 17.89 |
| Calcium carbonate filler | 74.80 |
| Plasticizer | 6.23 |

Base material 3 (parts by weight)

| | |
|---|---|
| PVC c-15 | 12.21 |
| Stabilizer | 0.88 |
| Polystyrene | 1.62 |
| PVC c-52 | 0.59 |
| Calcium carbonate filler | 70.59 |
| Talcum powder | 9.71 |
| Plasticizer | 4.41 |

Among them, base material 1 was a hard material, base material 2 was a soft material, and base material 3 plasticized relatively quickly, had a smoother surface, and could be used as an upper layer material. According to requirements of a designed texture, the above three base materials were mixed with corresponding colorants, to prepare particles of different colors by means of extrusion.

(2) Distribution: The design pattern to be fabricated was imported into a control computer of a digital distribution machine. The particles of different colors were put into raw material barrels of the digital distribution machine. Particles of corresponding colors were used according to designed colors, and each color could be controlled by a digital program to move left and right. A conveyor belt under the digital distribution machine started to run, the particles were sprinkled on the conveyor belt, and the pre-designed pattern was formed on the conveyor belt.

(3) Calendering: Heat treatment was carried out upon completion of the distribution, and then the particles were pressed and formed by a steel belt calender to obtain a substrate with a full body stone texture.

(4) Bottom layer and surface treatment: A digital printer was used to print the same pattern as the substrate pattern on the substrate to make the whole clearer, and then a UV paint was roll-coated for surface brightness and haze treatment and protection, and finally an acoustic layer was applied below the substrate to give a full body textured floor.

### Example 2

In this example, a semi-full body textured floor was prepared, and a preparation method therefor was substantially the same as that in Example 1, except that in step (2), a conveyor belt in this example carried a PVC board and passed through a distribution machine, and particles were sprinkled on the PVC board, followed by calendering to give a semi-full body textured substrate.

### Example 3

In this example, a full body textured floor was prepared, and a preparation method therefor was substantially the same as that in Example 1, except that in step (4), a pattern was not printed, but a match pattern was printed on the substrate: to a paint of one color in multi-color paints of the printer, a cracking resin and a photosensitizer were added to form a cracking ink; the cracking ink was printed on lines that were to produce deep and shallow textures, and was then irradiated with UV light; after the cracking ink absorbed UV energy, the UV paint on the surface was peeled off, forming embosses with different heights, and then a UV paint was roll-coated for surface brightness and haze treatment and protection.

The examples of the present disclosure have been described in detail above, but the present disclosure is not limited to the examples described above, and various changes can be made within the scope of knowledge possessed by those of ordinary skill in the art without departing from the spirit of the present disclosure. Furthermore, the examples of the present disclosure and features in the examples may be combined with each other without conflicts.

1. A full body textured material, comprising a textured substrate, wherein the internal texture of the substrate extends to the surface, the components of the substrate comprise a thermoplastic polymer and a filler, the filler is one of an inorganic filler or a natural plant fiber filler, and the texture is obtained by performing distribution by a digital distribution machine.

2. The full body textured material according to claim 1, wherein the texture is a stone texture or a wood texture.

3. The full body textured material according to claim 1, wherein a pattern layer and/or a protective layer is further provided on the substrate, and the protective layer is a UV cured layer or a wax layer.

4. A preparation method for the full body textured material according to claim 1, comprising the following steps:
S1: importing a design pattern to be fabricated into a control computer of a digital distribution machine, placing base materials of different colors in raw material barrels of the digital distribution machine, and using a base material of a corresponding color according to a designed color;
S2: starting to run a conveyor belt under the digital distribution machine, and sprinkling the base materials to form the preset pattern; and
S3: upon completion of the distribution, performing a compression forming treatment on the base materials by a forming device to obtain the substrate.

5. The preparation method according to claim 4, wherein the formulation of a base material comprises a thermoplastic polymer, a filler, and a colorant, and the ratio of the thermoplastic polymer to the filler is adjustable according to requirements, or a plasticizer can be added to formulate base materials with different hardness and softness, and colorants of different colors can be employed in different base material formulations; and the base materials are one or more of granular, powdery, flaky, or viscous.

6. The preparation method according to claim 5, wherein the granular base material is prepared by mixing raw materials, carrying out granulation by means of extrusion or calendaring, and performing crushing and screening.

7. The preparation method according to claim 4, wherein the substrate can be fabricated into a full body textured substrate or a semi-full body textured substrate; when the substrate is full body textured, the base materials in step S2 are directly sprinkled on the conveyor belt; when the substrate is half-body textured, the conveyor belt carries a monochromatic base through the digital distribution machine, and the base materials in step S2 are sprinkled on the monochromatic base, an upper part of the formed substrate has a full body texture, and the lower part is monochromatic.

8. The preparation method according to claim 7, wherein the monochromatic base is a plank or a roll, or is a base layer formed using a recycled material to perform thorough sprinkling and spreading.

9. The preparation method according to claim 4, further comprising a step of performing a surface treatment on the substrate after step S3: performing waxing or UV surface brightness and haze treatment on the surface of the substrate, or printing with a digital printer a pattern the same as the substrate pattern, or printing a match pattern according to the pattern of the substrate.

10. The preparation method according to claim 9, wherein when the match pattern is printed, a water-based ink, a UV ink, an oil-based ink, a corrosion ink, or a peeling ink can be used to perform texture stacking or depression treatment on the printed pattern according to the substrate, so as to present textures of the substrate.
